(19) United States
(12) Patent Application Publication
(10) Pub. No.: US 2026/0303956 A1
(43) Pub. Date: Oct. 1, 2026

(54) COORDINATED MOTION METROLOGY DEVICE

(71) Applicant: Nanoverse Technologies Ltd, Beaverton, OR (US)

(72) Inventors: Jeff Albelo, Beaverton, OR (US); William Robertson, Beaverton, OR (US); David Tasker, Beaverton, OR (US); Jeremy Lord, Beaverton, OR (US)

(73) Assignee: Nanoverse Technologies Ltd, Beaverton, OR (US)

(21) Appl. No.: 19/089,402

(22) Filed: Mar. 25, 2025

(51) Int. Cl. H04N 23/60; G02B 21/00; G03B 7/08; H04N 23/45; H04N 23/56; H04N 23/74; H04N 23/90

(52) U.S. Cl. CPC H04N 23/64; G02B 21/0036; G02B 21/0052; G03B 7/08; H04N 23/45; H04N 23/56; H04N 23/74; H04N 23/90

(57) ABSTRACT

A Bright Field—Dark Field (BF-DF) metrology device and methodology for the surface scanning of semiconductor and transistor components that implements a positional frame of reference for the acquisition of pixilated and point data. It provides a system of coordinated motion used during the scanning that integrates the precise position of each scan frame. It coordinates the motion of the metrology stage along its scan path with the pulsation of structured light from the rotation of the modulator wheel and the shuttering of the BF and DF line scan cameras. Each pixilated and point data is connected to a positional coordinate (X Y C) from the positional frame of reference. This allows for a plethora of increased efficiencies in reduced scan time, minimized oversampling, and shortened image processing time.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to the surface inspection of Si wafers, semiconductor devices, including microchips and transistors, and more particularly to the technology of bright field—dark field metrology.

### BACKGROUND

As semiconductor devices become even smaller and more complex in design, the role of precise surface measurement down to the nanometer scale during semiconductor fabrication to ensure the correct structure and functionality, is paramount. Metrology occurs between the various successive steps of fabrication. As such, it consumes valuable fabrication time.

In Bright Field—Dark Field (BF-DF) metrology, cameras capture a plethora of images as point cloud data. These pixelated images must be stitched together and processed to develop digital data and images useable for detection of surface irregularities or flaws. This involves a computer intense algorithmic and computing process to interlink these images and develop a 3-D mapping of the Si wafer. This processing time could be greatly reduced and the precision of the images produced greatly increased, if each photo or cloud data point were associated with a common frame of reference. With existing metrology systems, scans on the same Si wafer are neither identical nor repeatable. None of the data points can be snapped to a dimensional grid, because there is no XYZ axis data associated with the individual pixel images. They lack a dimensional reference. Current metrology does not have the ability to precisely, positionally link the images and must rely on excess oversampling and slower, less precise methods of processing the data points into useable material.

Henceforth, an apparatus and method for BF-DF metrology that provides for a more precise and quicker scanning, would fulfill a long-felt need in the semiconductor fabrication and inspection industry. This new invention utilizes and combines known and new technologies in a unique and novel configuration to overcome the aforementioned problems and accomplish this.

### BRIEF SUMMARY

In accordance with various embodiments, a BF-DF metrology apparatus and methodology that provides coordinated motion in at least the scan axis (X or Y), the A axis (modulator wheel rotational axis) and the camera with synchronization of the shuttering control of the line scan BF-DFF cameras, is provided.

In one aspect, a BF-DF metrology apparatus and methodology where each captured data point and image in its point cloud, is tagged with positional XYC coordinates and an acquisition time stamp.

In another aspect, a BF-DF metrology apparatus that for each pixelated image acquired (each data point) provides a positional coordinate from a common dimensional frame of reference. This allows for smaller segments of the point cloud data to be parsed/segregated out and processed simultaneously saving time, since all data can easily be linked together later by their positional coordinates.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### BRIEF DESCRIPTION OF THE DRAWINGS

A further understanding of the nature and advantages of particular embodiments may be realized by reference to the remaining portions of the specification and the drawings, in which like reference numerals are used to refer to similar components.

FIG. 1 is a representational image of a coordinated motion BF-DF metrology device with the Z (focus) axis adjustable from the metrology chuck;

FIG. 2 is a representative image of a coordinated motion BF-DF metrology device with the Z (focus) axis adjustable from the metrology stage;

FIG. 3 is a top view of a partial scan pattern of the preferred embodiment coordinated motion BF-DF metrology system;

FIG. 4 is a top view showing the first scanning pass with the start, stop and run up scanning paths and locations; and

FIG. 5 is a flow chart showing the methodology of coordinated motion BF-DF metrology to provide a common frame of reference for each data point.

### DETAILED DESCRIPTION OF CERTAIN EMBODIMENTS

Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present.

As used in the description of the inventive concept and the appended claims, the singular forms “a,” “an,” and “the” are intended to include the plural forms as well, unless the context clearly indicates otherwise. It will also be understood that the term “and/or” as used herein refers to and encompasses all possible combinations of one or more of the associated listed items.

A used herein the term “position sensor” refers to any of a plethora of devices that generate and relay data/electrical pulses that allow for the determination of the position (two-or three-dimensional location), and/or velocity (linear or rotational) of the device they are associated with. Commonly, they are connected to the drive motor or motor shaft of the device's prime mover. Devices herein that utilize these position/speed sensors are the A axis drive of the modulator wheel, the X, Y and Z axis drives of the metrology stage or the chuck, and the C axis drive of the chuck. In the preferred embodiment this sensor may be an encoded motor shaft, a Hall effect sensor, a stroboscopic tachometer, or the equivalent, placed on the device or any part thereof its motor assembly.

As used herein, the term “wafer map” refers to a set of instructions showing the location of everything the customer has or is building on a Si wafer. It lays out the grid pattern of the semiconductors or transistors and their parts on the wafer as well as the wafer's edge notches and fiducial markings.

As used herein, the term “BF-DF” refers to bright field—dark field metrology.

As used herein, the term “C axis” refers to the rotational axis (theta) of the metrology chuck that the Si platter resides on for either alignment or scanning.

As used herein, the term “A axis” refers to the rotational axis (theta) of the modulator wheel.

As used herein, the term “coordinate system” refers to an X Y C coordinate where the X and Y are left-handed Cartesian coordinates of the X axis and Y axis of the Si wafer, and the C is the theta rotation of the Si wafer about the Z axis (which is referred to herein as the C axis). It is to be noted the Z axis motor assembly raises or lowers the metrology chuck (or on some designs, the metrology stage) along the Z axis while the C axis motor assembly rotates the metrology chuck in theta about/around the Z axis.

As used herein, the term “camera shuttering” refers to the operation of the shutter of the line sensor camera to capture of a set of sequential pixelated photos of the area being scanned by the metrology device. A common speed for BF-DF camera shuttering is 300 kHz. There is a shuttering control on the cameras that can be coordinated with the rotation of the modulator wheel and the movement of the metrology stage in the scan axis.

As used herein, the term “approximately” when referring to the pixel array size means the stated size number of pixels plus or minus 30% in length and 300% in height. A standard pixel array of a line scan camera is 16,000 pixel long and 1 pixel high.

As used herein, the term “structured light” refers to a beam of light that has been passed through an optical modulator's grids or slits to project a known pattern of grids or bars onto the Si wafer surface to be examined. These bars deform when striking surfaces on the wafer. Cameras capture reflected or refracted pixelated images of these and a connected computer can algorithmically process these images to produce a three-dimensional picture showing the depth, height and surface information of the surfaces in the scene.

As used herein, the term “program speed” refers to the speed of movement of the metrology stage, or the metrology chuck or the modulator wheel when it has accelerated from a standstill and attained a velocity (rotational or linear) at which it will remain constantly while coordinated motion metrology is in progress. The coordinated motion metrology involves the motion of the scan axis (linear motion of the metrology stage or circular motion of the metrology chuck or a hybrid thereof) reaching program speed with the modulator wheel rotation's program speed and the shuttering of the line scan cameras.

The present invention relates to a novel BF-DF metrology that employs simultaneous, coordinated motion of the modulator wheel about its A axis, the BF-DF camera shuttering, the metrology stage movement in the X or Y axis and/or the metrology chuck rotational (theta) motion about the C axis. This coordinated motion allows for a common frame of reference for the point cloud data to be established, wherein each individual data point is assigned a positional coordinate within a positional reference system (X, Y, C). This system allows for repeated scans with the same results, minimalized stitching, higher scanning speed, better resolution and faster back-end data processing, as the precise location of each data point or pixel in the point cloud of pixelated data generated by the BF-DF cameras, is known and can be dimensionally linked to every other data point.

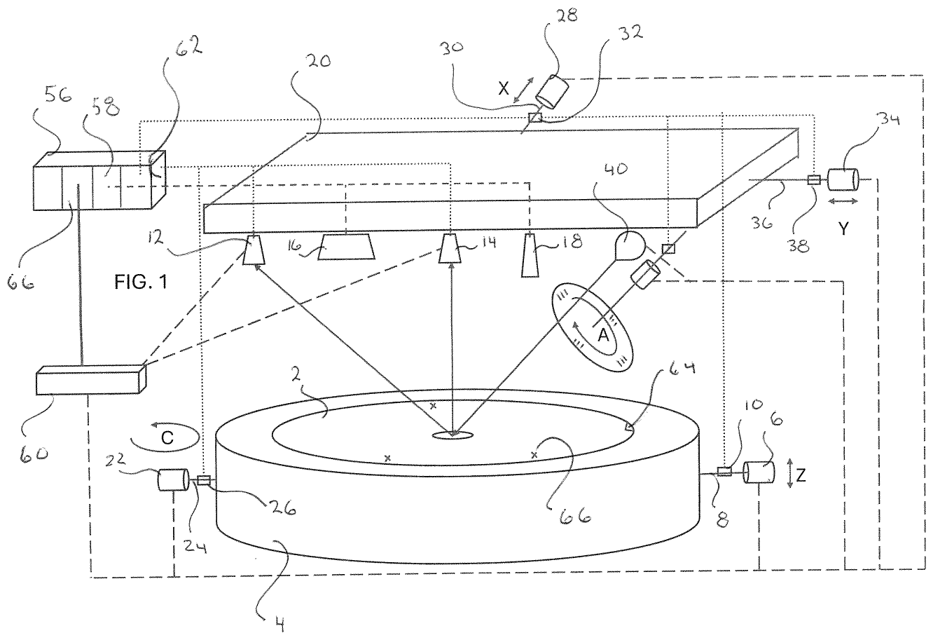

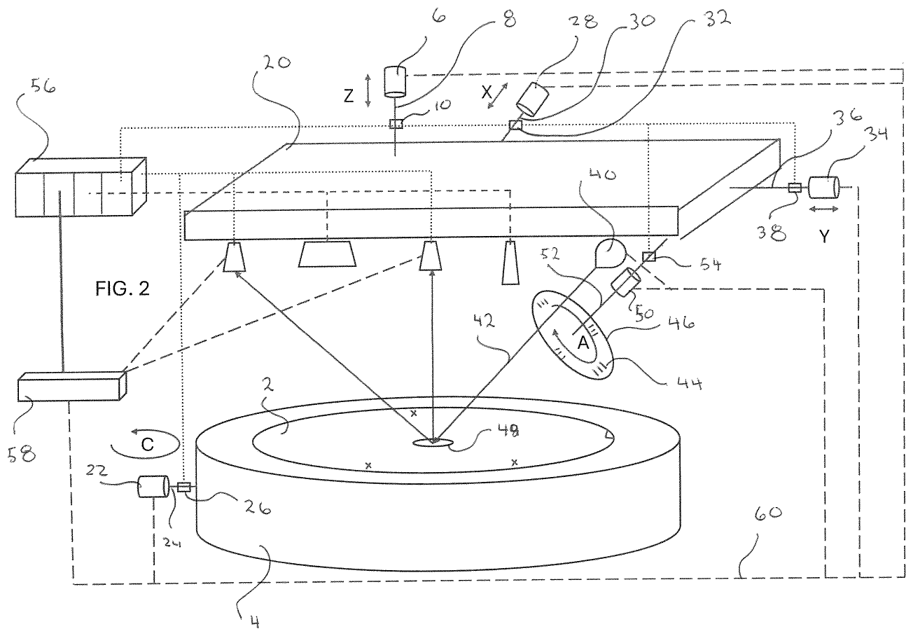

Looking at FIGS. 1 and 2, two embodiments of the coordinated motion metrology system can best be seen. The Si wafer 2 resides on top of a chuck 4 that is adjustable in the Z axis with the connected Z axis motor assembly. (The motor assembly includes the motor 6, the mechanical linkage 8 that enables it to move the chuck 4, and the position/speed sensor 10.) The vertical distance or gap between the chuck 4 and the BF camera 12, DF camera 14, and the two area scan alignment cameras (macro camera 16 with a large field of view used for navigation, and micro camera 18 with higher magnification used for wafer alignment) is adjusted to focus the various cameras. The BF and DF cameras 12 and 14 and the two alignment cameras 16 and 18 on the metrology stage 20, are selected to have similar focal lengths allowing each pair to be focused in unison. The C axis motor assembly (similarly comprising motor 22, mechanical linkage 24 and position/speed sensor 26) enables the rotational movement of the chuck 4, around the C axis.

In the alternate embodiment of FIG. 2, it can be seen that the Z axis motor assembly 6, 8, 10 is connected to the metrology stage 20 and moves the stage 20 in the Z axis to focus the cameras rather than moving the metrology chuck 4.

The BF and DF cameras 12 and 14 are line scan cameras that capture linear pixelated scan strips of the structured light as it is reflected and refracted off the Si wafer's surface. Preferably, the camera's pixel array is greater than 9000 pixels in length and less than 10 pixels in height, and in the preferred embodiment is approximately 16,000 pixels long and 1 pixel high. These BF-DF cameras are electronically connected to a main computer for the transfer of point cloud data (pixelated image data). The BF-DF cameras are also connected to the motion controller 58, which triggers their shuttering in coordination with the movement of the metrology stage 20 and the passage of structured light 42 through the slits 44 in the modulator wheel 46. In the preferred embodiment, the BF camera collects images reflected at approximately 45 degrees from face of the wafer and the DF camera collects images refracted at approximately 90 degrees from the face of the wafer.

The macro camera 16, and micro camera 18 are used for the location and positioning of the Si wafer 4 on the chuck. Their purpose is to provide images of the locating indicia on the Si wafer 2 to the main computer.

The metrology stage 20 is suspended above the chuck 4 and has an X axis motor assembly 28, 30 32 that moves the stage 20, and the devices mounted thereon in the X axis direction, and a Y drive motor assembly 34, 36, 38 that moves the stage 16 in the Y axis direction. Generally, the Z axis motor assembly that adjusts the gap between the metrology chuck and metrology stage to focus the four cameras is connected to the metrology chuck, however in other embodiments it may be connected to the metrology stage.

There is a light source 40 mounted on the metrology stage 20 that projects a structured light 42 through the slits 44 of a modulator wheel 46. In the preferred embodiment this structured light 42 has an elliptical configuration 48 and is collimated in one axis (preferably the X axis) and angled in the other axis (preferably the Y axis). The modulator wheel 46 has a planar configuration with radial slits 44 spaced about its perimeter. The modulator wheel 46 is rotatable about the A axis by the modulator motor assembly 50, 52 54 which is connected to the modulator wheel 46. This elliptical light 42 is projected through the slits 44 on the modulator wheel 46 to provide the elliptical, structured scan light 48 onto the surface of the Si wafer 2 at a scan angle (in the preferred embodiment this is an acute angle).

As noted above, each X, Y, Z, A and C axis motor assembly has an associated motor, 28, 34, 6, 50 and 22, a mechanical linkage 30, 36, 8, 52 and 24 and a position sensor 32, 38, 10, 54 and 26. All position sensors are in communication with and reporting position data in real time to the main computer 56, that can be used to algorithmically determine the position and speed of the associated devices in real time. Knowing these positions, the main computer 56 can algorithmically manage the coordinated motion of the metrology stage 20 in the X and Y axes as well as the pulsing of the light 42 through the rotation of the modulator wheel 46, by sending X, Y, and A motor drive signals to the motion controller 60.

A main computer 45 is in communication with the four cameras and the five position sensors. It has an image processing module 58 that receives pixelated data points of the scanned Si wafer which together form the data point cloud from the BF-DF camera. It receives, algorithmically processes and stores this pixelated data. When processed, this data provides a three-dimensional representation of the wafer 2 and all its semiconductor and transistor components that can be used to verify the integrity of the devices on the wafer.

The main computer 56 also has a coordinated motion module 66 that processes positional and speed data from the positional sensors 32, 38, 6, 26 and 38 to use generating signals it sends to the coordinated motion controller 60.

There is a coordinated motion controller 60 connected to the main computer 56, the X, Y, Z, C and A motors assemblies, the BF-DF cameras 12 and 14 and the light source 40. Upon the receipt of a signal from the main computer's alignment module 62 or coordinated motion module 66, it provides extremely precise coordinated drive signals to the various components to accomplish the following tasks: focus the cameras in the Z axis, align the wafer to its theta reference coordinate position in C axis, drive the metrology stage 20 in the X or Y axes, rotate the modulator wheel 46 in the A axis, turn on/off the light source 40 and operate the shuttering of the BF and DF cameras. During wafer scanning, the coordinated motion controller 60 keeps the motion of the various devices coordinated for the collection of pixelated images that are each related through a common frame of reference.

The main computer 56 is connected to the motion controller 60 and provides logic instructions to the motion controller 60 for the operation of the five motor assemblies and the BF-DF cameras 12 and 14, to focus the four cameras in the Z axis, drive the metrology stage 20 in the X and Y axes, rotate the modulator wheel 46 in the A axis, rotate the metrology chuck 4 in the C axis, and operate the BF-DF camera's shuttering.

The main computer 56 has an alignment module 62 that has the customer's wafer map stored therein its memory. This wafer map is provided by the client (the entity having the semiconductors/transistors fabricated on that Si wafer 2) and provides the layout of the wafer showing everything on the wafer and its location. This includes the semiconductors/transistors as well as the positional indicia. These positional indicia may include edge notches 64, fiducial crosses 66 and center markings. The alignment module 62, using the images showing the positional indicia of the Si wafer 2 provided by the area scan alignment cameras 16 and 18, in conjunction with the wafer map, accurately determines the Si wafer's position on the metrology chuck 4. The wafer 2 will not have been placed in its perfect alignment position by the end effectors of the robotic arm that placed the wafer on the metrology chuck 4, although it will be close. Generally, the wafer 2 will be placed in an offset position with respect to the alignment of the center of the Si wafer to the center of the metrology chuck 4 with respect to the X-Y axes or in an angular rotation in theta (Z axis) from its predetermined precise alignment position (the reference position).

For coordinated motion metrology to work, the wafer scan must begin in a common frame of reference with the wafer in its X Y C (0,0,0) reference coordinate reference position where C is the theta rotation in the Z axis. The pattern on the wafer 2 must be aligned to the axis of the scanning system. The main computer's alignment module 56 uses the alignment camera's images, to algorithmically generate and provide a drive signal to the motion controller 60 to operate the C axis motor assembly to precisely rotate the metrology chuck 4 to the alignment position, as well as to determine an X-Y offset for the Z axis in the computer software. This offset eliminates the offset of the wafer placement from the center of the chuck and thus can determine the necessary metrology stage's X and Y axis movement instructions sent to the motion controller to compensate for this initial misalignment. This level of positional precision is needed to align the wafer's grid to that of the wafer map. The alignment module 62 is responsible for aligning the wafer 2 to the reference coordinate system.

Once the Si wafer 2 has been precisely placed, adjusted and dimensionally located on the chuck 4, a XYC positional coordinate starting reference position 0, 0, 0 is assigned in the main computer 56. From this point on, with the main computer's coordinated motion of the metrology stage in the X and Y axis, in conjunction with the shuttering of the BF-DF line scan cameras, coincident with the passage of the structured light through the modulator wheel slits 44 onto the scan surface of the Si wafer, each of the data points in the point cloud that is provided to the main computer, is linked to a positional coordinate system based on a known reference position (0, 0, 0).

With the wafer 2 linked to the known positional (coordinate) reference frame, scanning the wafer while dynamically coordinating the scan elements of the X or Y axis metrology stage linear movement, (and optionally, the metrology chuck's theta rotation), the A axis rotational speed of the modulator wheel 46, and the shuttering of the BF-DF line scan cameras 16 and 18, allows a precise three-dimensional imaging of the Si wafer's surface to be processed that requires a minimal, if any, photo data stitching. This coordinated motion and data acquisition provides a much more precise imaging, allows scanning to proceed at a faster rate, allows the image date to be parsed out in smaller bundles for simultaneous processing, and allows for a narrower field of view from the BF-DF cameras. All which add up to a much faster, more precise data processing to generate the Si wafer's surface mapping.

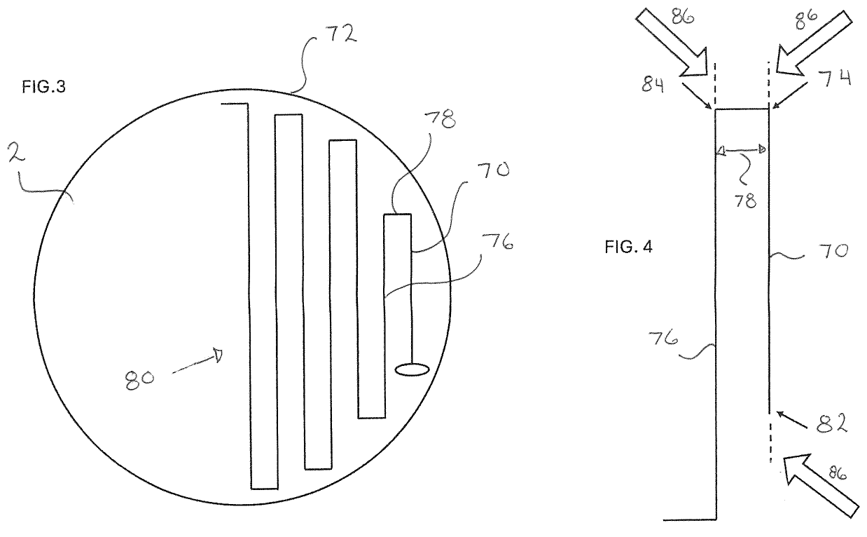

In general terms of operation, after the wafer is precisely rotationally located in theta on the chuck 4, and the dimensional offset has been determined with the compensating positional coordinates input to the computer's software, the scanning can begin. Generally, the scanning will proceed with a back and forth offset pattern accomplished by the metrology stage's movement in the X axis. (See FIGS. 3 and 4) The X axis motor assembly 28, 30 and 32 traverses the metrology stage linearly in the X axis above the wafer 2 on the metrology platter 4, such that the elliptical light 42 traces a first X axis linear path 70 within the edges 72 of the wafer 2. Upon reaching the end of the first X axis linear path 74 the Y axis motor assembly 34, 36 and 38 will move and offset the metrology stage 20 in the Y axis direction an offset amount 78 to the beginning of the next X axis path 84 to offset the X axis location in the Y axis slightly less than the width of the light's ellipse 42 on the wafer 2. The X axis motor assembly 28, 30 and 32 will traverse the metrology stage 20 in the second X axis linear path 76 (which runs parallel to the first X axis linear path 70) again within the edges 72 of the wafer 2. At this point, another Y axis offset will be performed and this X axis and Y axis stage movement pattern 80 repeated with varying X axis linear paths until the entire wafer 2 has been scanned.

To ensure precise, repeatable scans within a few pixels, there must be no mechanical variation in the speed of the linear movement of the metrology stage 20 (and optionally, if used for circular scanning, the rotational motion in the theta axis of the metrology chuck) and the rotational speed of the modulator wheel 46. The Since the BF-DF camera shuttering is purely electronic, the shuttering has immediate precision timing control by the computer/motion controller. It is imperative that all the coordinated motion does not slip out of synchronization as to do so would lose the ability for the scan image pixels to be precisely located with respect to the positional frame of reference. However, the motor assemblies cannot instantaneously bring their driven devices to their desired operating speeds and must go through an acceleration phase before being stabilized at this desired operating speed. This acceleration phase of the metrology would take the movement of the metrology stage, the modulator wheel and the BF-DF shuttering out of coordinated motion. To avoid this, there is an X axis pre-scan runup position 82 for any X axis path of the scan 70 is backed up behind the X axis scan start position 82 (the reference position, indicated by the dashed lines and arrow in FIG. 4). The modulator wheel 46 is similarly placed in its pre scan runup position a short rotational distance in the A axis in front of its scan start position. The motion controller 60 initiates the X axis motor 28 and the A axis motor 50 and by the time the metrology stage and the modulator wheel reach their scan start positions, they are up to program speed. As they reach their scan start positions, stabilized at their full operating (program) speeds the light source 40 is switched on to provide elliptical structured light 42 through the slits 44 in the modulator wheel 46 to provide the elliptical light 48 at the reference position of the wafer, and simultaneously the shuttering of the BF-DF cameras begins to collect the reflected and refracted images.

When the metrology stage reaches the end of any X axis linear path 74, the light source 40, the A axis motor assembly, the X axis motor assembly and the camera shuttering are each powered off by the motion controller 60. The metrology stage 20 is then moved in the Y axis the offset amount 78 and the metrology stage 20 is positioned to its X axis pre scan runup position 86 before its X axis scan start position 84. The modulator wheel 46 undergoes a similar pre scan runup rotational positioning.

In conventional BF-DF metrology systems the X axis metrology stage would trigger the camera shuttering but the positions were not coordinated, thus if the wafer was scanned multiple times, the same scanned feature part of the wafer would appear in different images each time because there was no positional reference point linked to an established positional frame of reference. The measurements were thus impossible to repeat because in each scan the position of the feature in the pixelated image frame would shift because of the different, non-coordinated positions of the X axis and the modulator wheel's angle as the image was acquired. This type of scanning would then require excessive oversampling, excessive algorithmic processing and image stitching to create a crude representational image of the Si wafer's surface.

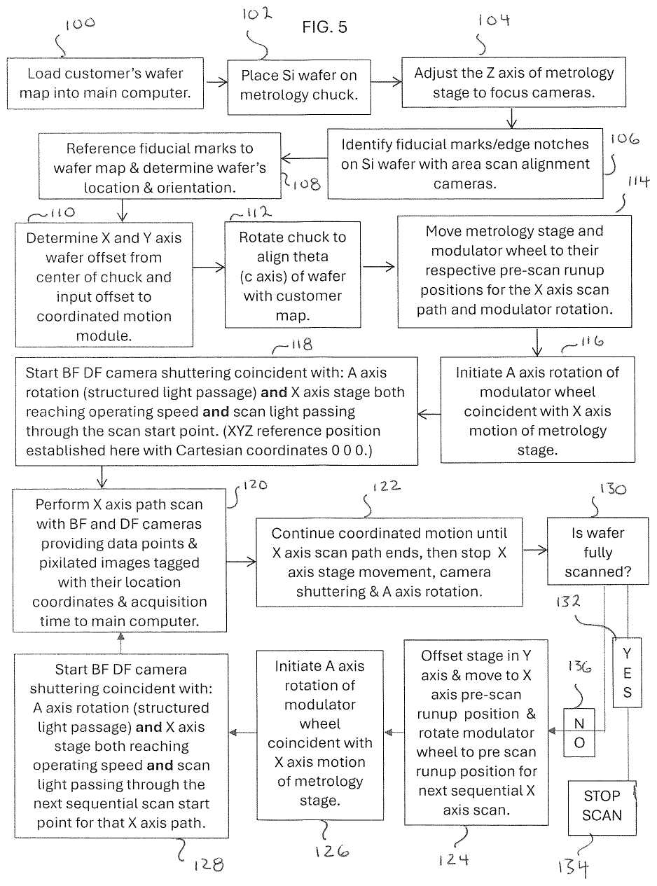

Looking at FIG. 5 the steps in the methodology of conducting coordinated motion metrology scanning can best be explained. They are as follows:

The customer's wafer map is loaded into the main computer for use in the alignment of the Si wafer to the reference coordinate system. 100 The robotic arm uses its end effectors to place the Si wafer in the metrology chuck. 102 The Z axis of the metrology stage or the metrology chuck is adjusted to focus the distance between the Si wafer and the alignment and BF-DF cameras. 104 The alignment cameras provide images to the main computer's alignment module that searches and identifies positional indicia on the Si wafer, such as fiducial crosses, edge notches, center markings. 106 The main computer determines the precise location of the Si wafer on the metrology chuck by referencing the recognized positional indicia to those on the wafer map. 108 The main computer algorithmically determines the Si wafer's X-Y offset from the center of the metrology chuck and provides this input to the coordinated motion module. 110 The main computer provides a signal to the coordinated motion controller to rotate the metrology chuck in theta (the C axis) to align the Si wafer with the wafer map. 112 The main computer's coordinated motion module provides a signal to the motion controller that drives the X axis and Y axis motor assemblies to move the metrology stage to the pre scan runup start position for the X axis scan path. 114 The main computer's coordinated motion module provides a signal to the motion controller that drives the A axis motor assembly to rotate the modulator wheel to its pre scan runup start position. 114 The main computer's coordinated motion module provides a signal to the motion controller that drives the A axis motor assembly to move the modulator wheel to the pre scan runup start position. 114 The main computer's coordinated motion module provides a signal to the motion controller that drives the A axis motor assembly to rotate the modulator wheel to its pre scan runup start position. 114 The motion controller starts the X axis motor assembly and the A axis motor assembly initiating their pre scan runups. 116 The light source is turned on simultaneously with the start of the camera shuttering when the metrology stage reaches its X axis scan start position (reference point) at program speed coincident with the modulator wheel reaching its scan start position at program speed. (This is the start of coordinated motion metrology.) 118 An X axis scan is performed between the edge limits of the Si wafer with the BF and DF line scan cameras acquiring images/point data with their associated positional coordinate location and time. The line scan cameras provide this point cloud data to the main computer for processing and storage. 120 When the X axis scan reaches the limit of its X axis path at that sector of the Si wafer, the light source, the modulator wheel, the camera shuttering and the X axis motor assembly are turned off. (Coordinated motion ends.) The motion controller jogs the Y axis motor assembly an offset distance approximately the length of the elliptical light projected on the Si wafer and then jogs the X axis motor assembly to put the metrology stage in its pre scan runup position. The motion controller jogs the A axis motor assembly to put the modulator wheel into its pre scan runup position. 124 The motion controller initiates the modulator wheel rotation and the metrology stage's X axis movement. 126 The light source is turned on simultaneously with the start of the camera shuttering when the metrology stage reaches its X axis scan start position (reference point) at program speed coincident with the modulator wheel reaching its scan start position at program speed. (This is another start of coordinated motion metrology in the reverse X axis direction.) 128 An X axis scan is performed between the edge limits of the Si wafer with the BF and DF line scan cameras acquiring images/point data with their associated positional coordinate location and time. The line scan cameras provide this point cloud data to the main computer for processing and storage. 120 When the X axis scan reaches the limit of its X axis path at that sector of the Si wafer, the light source, the modulator wheel, the camera shuttering and the X axis motor assembly are turned off. (Coordinated motion ends.) 120 repeat the last five steps 124, 126 128, 120 and 122 are until the wafer is fully scanned. 130, 132, 134 and 136.

With the BF-DF metrology scans completed, there can be a three-dimensional profile created in both visual images and point data in XYC coordinate mapping of specific areas of the wafer that can be evaluated for their Z axis height profiles to find defects and irregularities. With the location of each pixelated data point known in relation to a reference coordinate on the wafer, the raw data that is collected has both a high image quality (since shuttering occurs only when the source light is fully shining through the modulator wheel's slits) and a high location precision This allows the oversampling of the pixelated data to be shortened. Preliminary testing shows this may be reduced from the 16,000 pixel array to 9,000 pixels. Stitching is almost eliminated and the computational time to process the three-dimensional wafer image is shortened and can be parsed out in smaller data parcels for simultaneous processing because of the positional knowledge that accompanies each image scan simplifies the connection of all the data points (pixelated data) in the data cloud into a precise three-dimensional image.

The main computer and motion controller as described herein, and illustrated in the drawings, are described in terms of functional blocks, units and/or modules. Those skilled in the art will appreciate that these modules can be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the modules being implemented by microprocessors or similar, they may be programmed using software (e.g., microcode) to perform various functions discussed herein and may optionally be driven by firmware and/or software. Alternatively, modules may be implemented by dedicated hardware, or as a combination of dedicated hardware to perform some functions and a processor (e.g., one or more programmed microprocessors and associated circuitry) to perform other functions. Also, each module of the embodiments may be physically separated into two or more interacting and discrete modules without departing from the scope of the inventive concepts. Further, the modules of the embodiments may be physically combined into more complex modules without departing from the scope of the inventive concepts.

Typically, the main computer and motion controller include a system bus to which is attached processors, memory, e.g., random access memory (RAM), read-only memory (ROM), or other state preserving medium, storage devices, a video interface, and input/output interface ports. They can be controlled, at least in part, by input from conventional input devices, such as keyboards, mice, etc., as well as by directives received from another computer or device, feedback, or other input signal. As used herein, the term “main computer” is intended to broadly encompass a single computer or a system of communicatively coupled computers, microprocessors or microcontrollers or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The main computer and motion controller can include embedded controllers, such as programmable or non-programmable logic devices or arrays, Application Specific Integrated Circuits (ASICs), embedded computers, smart cards, and the like. The machine or machines can utilize one or more connections to one or more remote machines, such as through a network interface, modem, or other communicative coupling. Machines can be interconnected by way of a physical and/or logical network, such as an intranet, the Internet, local area networks, wide area networks, etc. One skilled in the art will appreciate that network communication can utilize various wired and/or wireless short range or long-range carriers and protocols, including radio frequency (RF), satellite, microwave, Institute of Electrical and Electronics Engineers (IEEE) 545.11, Bluetooth®, optical, infrared, cable, laser, etc.

Embodiments of the inventive concept can be described by reference to or in conjunction with associated data including functions, procedures, data structures, application programs, etc. which when accessed by a machine result in the machine performing tasks or defining abstract data types or low-level hardware contexts. Associated data can be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data can be delivered over transmission environments, including the physical and/or logical network, in the form of packets, serial data, parallel data, propagated signals, etc., and can be used in a compressed or encrypted format. Associated data can be used in a distributed environment and stored locally and/or remotely for machine access.

Embodiments of the invention may include a non-transitory machine-readable medium comprising instructions executable by one or more processors, the instructions comprising instructions to perform the elements of the embodiments as described herein.

While certain features and aspects have been described with respect to exemplary embodiments, one skilled in the art will recognize that numerous modifications are possible. Moreover, while the procedures of the methods and processes for building, assembling and using the devices described herein are described in a particular order for ease of description, unless the context dictates otherwise, various procedures may be reordered, added, and/or omitted in accordance with various embodiments. What is claimed as the invention, therefore, is all such modifications as may come within the scope and spirit of the following claims and equivalents thereto.

1. A coordinated motion bright field—dark field metrology device, comprising:
a metrology stage moveable to perform a scan in an X axis via an X axis motor assembly, and moveable to offset said X axis scan in a Y axis via a Y axis motor assembly;
a metrology chuck positioned beneath said metrology stage;
a modulator attached to said metrology stage, having a modulator wheel rotatable in an A axis by an A axis motor assembly and rotationally synchronized with said metrology stage's X axis scan;
a scan light source attached to said metrology stage, passing a scan light beam through said rotatable modulator wheel and presenting a structured scan light beam onto a target on said metrology chuck;
a dark field line scan camera attached to said metrology stage and with its shuttering synchronized to said X scan axis movement of said metrology stage and to said A axis rotation of said modulator wheel as said scan light source passes through said rotating modulator wheel;
a bright field line scan camera attached to said metrology stage and with its shuttering synchronized to said X scan axis movement of said metrology stage and to said A axis rotation of said modulator wheel as said scan light source passes through said rotating modulator wheel;
a motion controller connected to said X axis motor assembly, said Y axis motor assembly, said A axis motor assembly, said BF scan camera and said DF scan camera,
a main computer providing instructions to said motion controller for the coordinated, synchronized motion of said x axis scan, said modulator wheel rotation and said bright field and dark field camera shuttering.

2. The coordinated motion bright field—dark field metrology device of claim 1, further comprising:
a Z axis motor assembly connected to said metrology stage for movement of said metrology stage in a Z axis to focus said bright field and dark field cameras.

3. A coordinated motion bright field—dark field metrology device of claim 1, further comprising:
a Z axis motor assembly connected to the metrology chuck for movement of said metrology chuck in a Z axis to focus said bright field and dark field cameras.

4. The coordinated bright field—dark field metrology device of claim 1 wherein said structured scan light beam is elliptical is shape.

5. The coordinated bright field—dark field metrology device of claim 4 wherein said structured scan light beam has a first axis and a second axis, where said structured scan light beam is collimated in said first axis and angled in said second axis.

6. The coordinated bright field—dark field metrology device of claim 1 further comprising:
a C axis motor assembly connected to said metrology chuck for rotation around a Z axis to align said Si wafer for metrology and processing; and
at least one alignment camera connected to said metrology stage.

7. A coordinated motion bright field—dark field metrology device, comprising:
a rotatable metrology chuck;
a metrology stage positioned above said metrology chuck, said metrology stage translatable in an X axis via an X axis motor assembly and translatable in a Y axis via a Y axis motor assembly to perform a bright field—dark field metrology scan;
a modulator attached to said metrology stage, said modulator having a rotatable modulator wheel rotatable about an A axis by an A axis motor assembly;
a scan light source attached to said metrology stage, passing a scan light beam through said rotatable modulator wheel to present a structured scan light beam onto a target on said chuck;
a dark field line scan camera and a bright field line scan camera attached to said metrology stage;
a motion controller connected to said modulator wheel's A axis motor assembly, to said metrology stage's X axis and Y axis motor assemblies, and to a shuttering control of said dark field and bright field line scan cameras, and to said scan light source; and
a main computer providing coordinated motion signals to said motion controller to synchronize the motion of said metrology stage, said modulator wheel, a shuttering of said dark field and said bright field line scan cameras, and a powering of said scan light source so as to establish a frame of reference for acquired scan images;
a common frame of reference for each Si wafer scanned, created by said coordinated motion of said modulator wheel, said metrology stage, and said bright field—dark field camera shuttering, said common frame of reference having a positional coordinate for each scan image acquired by said bright field and dark field line scan cameras.
